(19) United States
(12) Patent Application Publication
(10) Pub. No.: US 2008/0233028 A1
(43) Pub. Date: Sep. 25, 2008

(54) Process and system for reducing sulfur trioxide emissions

(75) Inventor: Leif A. V. Lindau, Arlov (SE)

Correspondence Address: WIGGIN AND DANA LLP, ONE CENTURY TOWER, P.O. BOX 1832, NEW HAVEN, CT, 06508-1832, US

(73) Assignee: ALSTOM Technology Ltd

(21) Appl. No.: 11/728,058

(22) Filed: Mar. 23, 2007

(51) Int. Cl. B01D 53/50

(52) U.S. Cl. 423/244.07; 422/168

(57) ABSTRACT

A process for reducing an amount of sulfur trioxide present in a flue gas stream (20), including the steps of processing an alkaline material (24) to comprise a predetermined percentage of particles, based on the mass of alkaline material introduced into a flue gas stream (20), having a size less than a predetermined dimension and introducing the processed alkaline material (24) to the flue gas stream (20), wherein the processed alkaline material (24) reduces the amount of sulfur trioxide present in the flue gas stream (20).

### BACKGROUND OF THE INVENTION

1. Field of the Invention

This invention relates to a process and system for removing contaminants from a flue gas stream. More particularly, this invention relates to a process and system for removing sulfur trioxide present in a flue gas stream, or reducing an amount of sulfur trioxide present therein.

2. Description of the Related Art

Combustion of fuels, particularly coal, produces a stream of gas, known as “flue gas,” which contains, among other things, contaminants such as mercury, sulfur, and other acidic gases. Such contaminants must be removed from the flue gas stream or the amount present in the flue gas stream must be reduced prior to the flue gas being emitted to an environment, e.g., the atmosphere.

Although it varies among systems, approximately one percent of the sulfur contained in the combusted fuel leaves the boiler as sulfur trioxide. Sulfur trioxide typically reacts with moisture in the flue gas stream to form vapor phase sulfuric acid, which condenses in the lower temperature regions of the boiler. Condensation and collection of sulfuric acid can cause corrosion of the boiler and parts connected thereto. Sulfur trioxide and sulfuric acid that is released from the boiler must be removed from the flue gas stream or the amount present in the flue gas must be reduced before emission to the environment.

Sulfur trioxide is classified as a “Toxic Release Inventory” substance. Therefore, annual emission quantities must be reported to the Environmental Protection Agency. Accordingly, monitoring the emission of sulfur trioxide to an environment and reducing an amount emitted is one aspect of a flue gas stream cleansing process.

Removal or reduction of an amount of sulfur trioxide present in a flue gas has been performed by the addition of reagents such as sodium sulfite, sodium bisulfite, potassium sulfite, potassium bisulfite and mixtures thereof. Introduction of such materials, at various points in a flue gas cleansing system may interfere with the removal of other contaminants and may cause additional cleansing steps to remove the reagent and absorbed sulfur trioxide.

Clean and environmentally sound power generation and waste incineration requires economical air pollution control systems. Air pollution control systems are sometimes complex, and typically consist of stages for the removal of particulates, acid compounds, organic substances, heavy metals, as well as the disposal of by-products from these processes.

Two process types currently used to remove sulfur oxides from flue gas are wet flue gas desulfurization (WFGD) and dry flue gas desulfirization (DFGD). In WFGD, the flue gas enters a large vessel, e.g., a spray tower or absorber, which is generally referred to as a wet scrubber, where it is sprayed with water slurry, i.e., a mixture of water and at least partially insoluble matter, e.g., lime, limestone, or the like. The calcium in the slurry reacts with the SO₂ to form calcium sulfite or calcium sulfate. A portion of the slurry from the reaction tank is pumped into the thickener, where the solids settle before going to a filter for final dewatering. The calcium sulfite waste product is usually mixed with fly ash and fixative lime and disposed of in landfills. Alternatively, gypsum can be produced from the WFGD waste product.

In DFGD, a water slurry, e.g., water mixed with quicklime to form calcium hydroxide or similar, is introduced into a spray dryer tower. The slurry is atomized and injected into the flue gases where droplets react with SO₂ as they evaporate in the vessel. The resulting dry waste product is collected in the bottom of the spray dryer and in particulate removal equipment, e.g., an electrostatic precipitator (ESP) or bag filter. Typically, the dry waste product is collected from the particulate removal equipment and disposed of in landfills.

While WFGD and DFGD have the capability of removing a portion of the sulfur trioxide present in the flue gas stream, removal thereof is often slow and inefficient due to absorption and removal of other contaminants such as sulfur dioxide, and the like.

### BRIEF SUMMARY OF THE INVENTION

One aspect of the present invention relates to a process for reducing an amount of sulfur trioxide present in a flue gas stream. The process includes: processing an alkaline material to comprise a percentage of particles, based on a mass of alkaline material injected into a flue gas stream, that is a size less than a collection cut size of a wet flue gas desulfurization system, wherein said percentage of particles corresponds to an amount of particles that is equal to or less than an allowable particulate emission from said wet flue gas desulfurization system; and introducing said processed alkaline material to said flue gas stream, wherein said processed alkaline material is introduced upstream of said wet flue gas desulfurization system, thereby reducing the amount of sulfur trioxide present in said flue gas stream.

Another aspect of the present invention relates to a system for reducing an amount of sulfur trioxide present in a flue gas stream. The system includes: an alkaline material processed to comprise a percentage of particles to a size less than a collection cut size of a wet flue gas desulfurization system, wherein said percentage of particles is equal to or less than an allowable particulate emission from said wet flue gas desulfurization system; and means for introducing said alkaline material to said flue gas stream at a position upstream of said wet flue gas desulfurization system, wherein said alkaline material removes sulfur trioxide from said flue gas stream.

Another aspect of the present invention relates to a process for reducing an amount of sulfur trioxide present in a flue gas stream. The process includes: processing an alkaline material to comprise a predetermined percentage of particles having a size less than a predetermined dimension; and introducing said processed alkaline material to said flue gas stream, wherein said processed alkaline material reduces the amount of sulfur trioxide present in the flue gas stream.

These and other aspects are described in more detail below.

### BRIEF DESCRIPTION OF THE DRAWINGS

For the purpose of illustrating the invention, the drawing shows a form of the invention that is presently preferred. However, it should be understood that the present invention is not limited to the precise arrangement and instrumentalities shown in the drawing.

FIG. 1 is a process flow diagram of a flue gas cleansing system according to one embodiment of the present invention.

### DETAILED DESCRIPTION

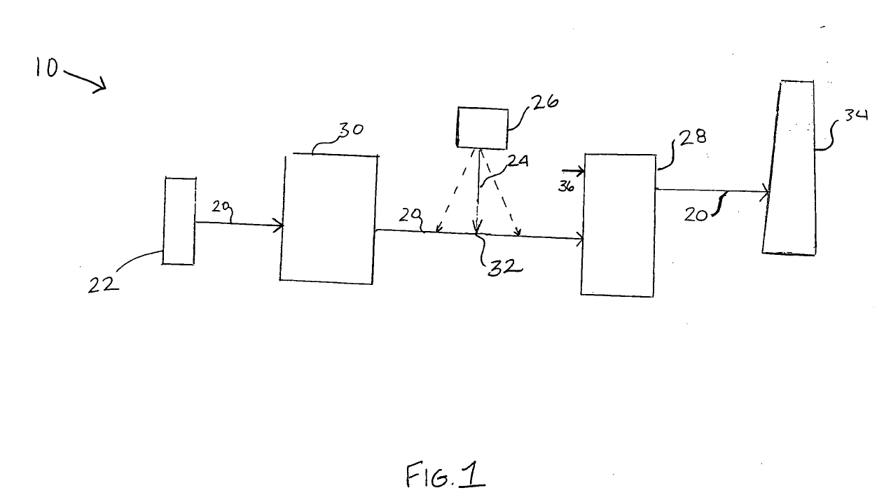

Referring now to the figure, where like numerals indicate like parts, and more particularly to FIG. 1, which illustrates a process and system 10 for reducing an amount of sulfur trioxide present in a flue gas stream, which utilizes a process for cleaning a flue gas stream 20 produced by a combustion source 22, e.g. boiler. Flue gas stream 20 is produced upon combustion of a fuel, such as coal. Flue gas stream 20 contains, among other things, acidic gases such as sulfur trioxide and sulfur dioxide, together with particulate material referred to as fly ash.

An alkaline material 24 is processed by a processor 26 and is thereafter introduced to flue gas stream 20 upstream of a WFGD system 28 to facilitate the removal of sulfur trioxide from the flue gas stream. Alkaline material 24 is introduced to flue gas stream 20 after the flue gas stream has been directed through a particulate control device 30 wherein at least a portion of the particulate material in the flue gas stream is removed.

Particulate control device 30 can be any device that can effectively remove particulate material from flue gas stream 20. Examples of particulate control device 30 include, but are not limited to, electrostatic precipitators (ESPs), bag houses, venturi scrubbers, and the like.

Alkaline material 24 can be any basic material effective to remove or reduce an amount of sulfur trioxide in flue gas stream 20. Examples of alkaline material 24 include, but are not limited to, lime (CaO), calcium hydroxide (Ca(OH)₂), limestone (CaCO₃), and magnesium containing materials, such as magnesium hydroxide and magnesium oxide.

Alkaline material 24 is introduced to flue gas stream 20 at a position 32, which is upstream of WFGD system 28. Position 32 can be located at any point upstream of WFGD system 28 and downstream of particulate control device 30. Alternatively, as shown by dashed lines in FIG. 1, there may be more than one position 32 in which alkaline material 24 can be introduced to flue gas stream 20. Multiple areas for introduction of alkaline material 24 would allow for greater amounts of the alkaline material to be introduced to flue gas stream 20, which in turn may increase an amount of sulfur trioxide absorbed from the flue gas stream.

Alkaline material 24 is typically in a powdered or dry form and can be introduced to flue gas stream 20 at position 32 by any way effective to do so. Examples of ways to introduce alkaline material 24 at position 32 include, but are not limited to, one or more nozzles, a sprayer, an injection system, a chute, or the like. A preferable technique for introducing alkaline material 24 to flue gas stream 20 is conveying the alkaline material pneumatically and injecting it to the flue gas stream with one or several parallel nozzles.

Alkaline material 24 is typically made and processed in processor 26 which is fluidly connected to flue gas stream 20 at position 32. Processor 26 can be any device that can process alkaline material 24 for introduction into flue gas stream 20. Processor 26 can be, for example, a mill, such as a mill for grinding limestone.

In processor 26, alkaline material 24 is processed to contain a particular size distribution of particles within the alkaline material. Specifically, alkaline material 24 is processed to a particular size distribution, where a predetermined percentage (x % by mass) of the particles in the alkaline material that is introduced to flue gas stream 20 is a size that is less than a predetermined dimension (y microns). The percentage (x % by mass) is based on the mass of alkaline material 24 that is introduced into flue gas stream 20. X % is equal to or less than the allowable particle emission from WFGD system 28, and y equals a collection cut size of the WFGD system. That is, alkaline material 24 is processed to have x % by mass of particles, based on the mass of the alkaline material introduced to flue gas stream 20, that is less than y microns, i.e., x %<y microns.

The allowable particle emission may be determined by a user's own standards, or by standards enforced by a particular government. The allowable particle emission may be determined by a gravimetric measurement, which is equal to:

mass of particles/amount of flue gas

The gravimetric measurement can be quantified in milligrams per meter cubed (mg/m³). The particle emission is measured at a position downstream of WFGD 28, e.g., in a stack 34.

The collection cut size is the maximum particle size that is permitted to exit from WFGD 28 and emitted by stack 34. Particles larger than the collection cut size are collected by WFGD 28 and are not emitted to stack 34. Particles that meet or are below the collection cut size are emitted to stack 34.

The allowable particle emission may have a gravimetric measurement between about 0.1 to about 50, while the collection cut size is between about 0.1 to about 10 microns. Accordingly, alkaline material 24 is processed by processor 26 to contain between about 0.1% to about 50% by mass of particles based on the mass of the alkaline material that is introduced to the flue gas stream, which is less than between about 0.1 micron to about 10 microns, i.e., 0.1-50% by mass <0.1-10 microns. The size ofthe particle is determined by measuring the particle's diameter. The particle size is measured after the particles have been produced. Production of the particles can occur by processor 26, which is connected to the combustion plant. Alternatively, alkaline material 24, having the correct parameters, can be obtained from a supplier and introduced to flue gas stream 20 at position 32.

If alkaline material 24 does not meet this particle distribution criteria, the alkaline material may be discarded or may be used in a scrubbing solution that is introduced to WFGD 28 to remove contaminants, such as sulfur dioxide, from flue gas stream 20. Alternatively, any alkaline material 24 that did not meet the above-discussed criteria can be reprocessed in processor 26 so the correct percentage of particles in the alkaline material are less than the collection cut size.

Processing alkaline material 24 to a particular size distribution having about x % of particles less than y microns generally allows for sulfur trioxide removal without interfering with particle emissions from stack 34. That is, if all alkaline material 24 introduced to flue gas stream 20 does not absorb sulfur trioxide or is not removed by WFGD system 28, emission of the alkaline material generally will not violate emission standards and generally will not impede the operation of system 10. Additionally, processing alkaline material 24 to such a size will typically eliminate the need for an additional particulate control device between position 32 and WFGD system 28 or at another location downstream of the WFGD system.

After alkaline material 24 is processed to a particular size distribution, it is introduced to flue gas stream 20 at position 32 to facilitate the removal, or reduce an amount, of sulfur trioxide present in the flue gas. Alkaline material 24 is introduced to flue gas stream 20 in an amount proportionate to the flow of the flue gas stream. For example, alkaline material 24 is introduced to the flue gas stream in an amount between 2 and 20 times greater than the mass of sulfur trioxide present in the flue gas stream, which is determined intermittently by processes and systems effective to do so.

When sulfur trioxide is in a gaseous form, it does not react easily with alkaline material 24. However, when sulfur trioxide is in a liquid form it is more reactive when it comes into contact with alkaline material 24, thus making it easier to remove from flue gas stream 20. Accordingly, flue gas stream 20, along with alkaline material 24, is conveyed to WFGD system 28. A scrubbing solution 36 is introduced to WFGD system. 28 to remove contaminants such as sulfur dioxide from flue gas stream 20. Flue gas stream 20 and alkaline material 24, along with any sulfur trioxide present in the flue gas stream, are contacted with scrubbing solution 36.

When sulfur trioxide is contacted with scrubbing solution 36 in WFGD system 28, the sulfur trioxide precipitates and forms a fine mist. The mist of the sulfur trioxide is subject to significant Brownian motion. During its movement, the sulfur trioxide mist will contact alkaline material 24 and react with it, thereby removing the sulfur trioxide from flue gas stream 20. At least a portion of alkaline material 24 that has reacted with the sulfur trioxide is collected and removed from flue gas stream 20 by scrubbing solution 36.

Alkaline material 24 along with the reacted sulfur trioxide is generally collected at the bottom of WFGD system 28 and treated or disposed of as necessary. Flue gas stream 20, and any alkaline material 24 remaining in the flue gas stream, is then typically emitted to the environment via stack 34.

Introduction of alkaline material 24 at position 32 is beneficial to system 10, as it increases the amount of sulfur trioxide removed from flue gas stream 20. Additionally, introduction of alkaline material 24 at position 32 eliminates the need for an additional particulate control device. Additionally, introduction of alkaline material 24 at position 32 does not hinder or impede performance of particulate control device 30 since the alkaline material is not introduced to flue gas stream 20 prior to its introduction to the particulate control device. Furthermore, particulate control device 30 does not have to be made larger in size to accommodate the increased amount of particulate material in flue gas stream 20.

Processing alkaline material 24 as described herein helps to ensure that any particle emissions will be less than that required by emissions standards.

One or more embodiments of the present invention have been described. Nevertheless, it will be understood that various modifications may be made without departing from the spirit and scope of the invention. Accordingly, other embodiments are within the scope of the following claims.

What is claimed is:

1. A process for reducing an amount of sulfur trioxide present in a flue gas stream, the process comprising:
processing an alkaline material to comprise a percentage of particles, based on a mass of alkaline material injected into a flue gas stream, that is a size less than a collection cut size of a wet flue gas desulfurization system, wherein said percentage of particles corresponds to an amount of particles that is equal to or less than an allowable particulate emission from said wet flue gas desulfurization system; and
introducing said processed alkaline material to said flue gas stream, wherein said processed alkaline material is introduced upstream of said wet flue gas desulfurization system, thereby reducing the amount of sulfur trioxide present in said flue gas stream.

2. A process according to claim 1, wherein said alkaline material is selected from a group consisting of lime, limestone, calcium hydroxide, magnesium oxide and magnesium hydroxide.

3. A process according to claim 2, wherein said alkaline material is limestone.

4. A process according to claim 1, wherein said percent of particles is between about 0.1% and about 50% by mass, based on a mass of said alkaline material introduced to said flue gas stream.

5. A process according to claim 1, wherein said size is between about 0.1 micron to about 10 microns.

6. A process according to claim 1, wherein said processed alkaline material is introduced to said flue gas stream in an amount between about 2 and about 20 times the amount of sulfur trioxide present in the flue gas stream.

7. A process according to claim 1, further comprising introducing said flue gas stream containing said processed alkaline material to said wet flue gas desulfurization system.

8. A system for reducing an amount of sulfur trioxide present in a flue gas stream, the system comprising:
an alkaline material processed to comprise a percentage of particles to a size less than a collection cut size of a wet flue gas desulfurization system, wherein said percentage of particles is equal to or less than an allowable particulate emission from said wet flue gas desulfurization system; and
means for introducing said alkaline material to said flue gas stream at a position upstream of said wet flue gas desulfurization system, wherein said alkaline material removes sulfur trioxide from said flue gas stream.

9. A system according to claim 8, wherein said alkaline material is selected from a group consisting of lime, limestone, calcium hydroxide, magnesium oxide and magnesium hydroxide.

10. A system according to claim 9, wherein said alkaline material is limestone.

11. A system according to claim 8, wherein the percent of particles is between about 0.1% to about 50% by mass, based on a mass of alkaline material introduced to said flue gas stream.

12. A system according to claim 8, wherein the collection cut size is between about 0.1 micron to about 10 microns.

13. A system according to claim 8, wherein said means for introducing is selected from a group consisting of a sprayer, a nozzle, an injection system and a chute.

14. A system according to claim 8, wherein said alkaline material is introduced to said flue gas stream in an amount between about 2 and about 20 times an amount of sulfur trioxide present in the flue gas stream.

15. A process for reducing an amount of sulfur trioxide present in a flue gas stream, the process comprising:
processing an alkaline material to comprise a predetermined percentage of particles having a size less than a predetermined dimension; and
introducing said processed alkaline material to said flue gas stream, wherein said processed alkaline material reduces the amount of sulfur trioxide present in the flue gas stream.

16. A process according to claim 15, wherein said predetermined percentage is equal to or less than an allowable particulate emission from a wet flue gas desulfurization system.

17. A process according to claim 15, wherein said predetermined dimension is equal to a collection cut size of a wet flue gas desulfurization system.

18. A process according to claim 15, wherein said predetermined percentage is between about 0.1% and about 50% by mass, based on a mass of the alkaline material introduced to said flue gas stream.

19. A process according to claim 15, wherein said predetermined dimension is between about 0.1 micron and about 10 microns.
